(19) United States
(12) Patent Application Publication
(10) Pub. No.: US 2006/0136145 A1
(43) Pub. Date: Jun. 22, 2006

(54) Universal reference standard for normalization of microarray gene expression profiling data

(76) Inventors: Kuo-Jang Kao, Gainesville, FL (US); Hsun-Chih Sean Kuo, Taipei (TW); Andrew T. Huang, Durham, NC (US)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/090,294

(22) Filed: Mar. 28, 2005

Related U.S. Application Data
(63) Continuation-in-part of application No. 11/015,764, filed on Dec. 20, 2004, now abandoned.

(51) Int. Cl. G06F 19/00

(52) U.S. Cl. 702/20

(57) ABSTRACT

A method of normalizing gene expression data obtained on a given microarray for a particular biological samples, comprising sorting said data as a function of expression degree for each gene, sorting a reference standard of gene expression data according to the same function of expression degree, and normalizing the expression degree of said particular gene expression data to the corresponding value in the reference standard, the reference standard having been obtained from gene expression data which is other than said particular gene expression data. The method is applicable for normalizing data obtained on a given microarray under varying conditions, including updates in associated instrumentation.

This application is a continuation-in-part of U.S. application Ser. No. 11/015,764 filed Dec. 20, 2004 which is incorporated by reference herein in its entirety.

The material in the compact disc of the appendix of parent application Ser. No. 11/015,764 is fully incorporated by reference herein, the compact disc containing the file “Reference Standards.txt,” created Dec. 16, 2004, size: 750 KB.

### BACKGROUND

Recent advancement in high-density DNA or oligonucleotide microarray technology makes it possible to measure the expression of large numbers of genes in tumor and other tissues. Because tumor and other disease behavior is dictated by the expression of thousands of genes, “gene expression profiling,” coined for such an approach, allows us to predict clinical behavior and consequences of neoplastic diseases and to effectively manage clinical problems of patients (Golub T R, et. al. Science 286 (1999):531-537; Bittner M, et. al. Nature 406 (2000):536-540; Perou C M, et. al. Nature 406 (2000):747-752; Hedenfalk I, et. al. New Eng J Med 344 (2001):539-548; Khan J, et. al. Nature Med 7 (2001):673-679; Alizadeh A A, et. al. Nature 403 (2000):503-511; Dhanasekaran S M, et. al. Nature 412 (2001):822-826; Shirota Y, et al. Hepatology 33 (2001):832-840; Ramaswamy S, et. al. PNAS 98(2001):15149-54; van't Veer L J, et. al. Nature 415 (2002):530-536; Shipp M A, et. al. Nature Med 8 (2002):68-74; Armstrong S A, et al. Nature Genetics 30 (2002):41-47). However, analyses of microarray data for clinical application require comparison with prior results generated at different times, from multiple arrays, under differing experimental conditions, in a database. This is a difficult problem in comparison, e.g., to (internal) normalization of data within a given experimental set, e.g., normalization of data comparing, e.g., a drug's effect on a cell's gene expression versus the cell's gene expression profile before application of the drug. Consequently, the issue of external normalization arises using a universal reference standard for a given array type.

The normalization of microarray data to address variations that may obscure results and interfere with data analysis is a major issue. These obscuring experimental and/or technical variations usually result from sample preparation (e.g. different labeling efficiency of cRNA targets, varying amounts of target cRNA, different laboratory environment, etc.), production of microarrays, and processing of microarrays (e.g. scanner differences, etc.). Thus, normalization of gene expression profiling data is required to correct these obscuring variations before formal data analyses can reliably be performed.

Many different approaches for normalization have been reported (e.g., Bolstad et al. Bioinformatics 19 (2063):185-193; Park T et al. BMC Bioinformatics 4 (2003):33-45). A systematic comparative study of different methods (Bolstad et al. Bioinformatics 19:185-193,2003) showed that the quantile normalization method is faster and offers comparable performance in reduction of variability and bias across microarrays. However, a sufficiently appropriate reference standard for reliable quantile normalization of gene expression profiling data has not been available.

### SUMMARY OF THE INVENTION

This invention relates to a method of normalizing gene expression data obtained on a given microarray for a particular biological sample comprising normalizing said data using reference standard gene expression data, which was obtained on a microarray containing the same genes as said given microarray by measuring expression of said genes from different sets of biological samples different from said particular sample, averaging expression data for each gene within said sets to calculate reference standard expression values for said genes for each set, and determining that the correlations of said reference standard values among said sets are sufficiently highly significant that the reference standard values for each set are essentially identical.

In another aspect, this invention relates to a method of normalizing gene expression data obtained on a given microarray for a particular biological samples, comprising sorting said data as a function of expression degree for each gene, sorting a reference standard of gene expression data according to the same function of expression degree, and normalizing the expression degree of said particular gene expression data to the corresponding value in the reference standard, the reference standard having been obtained from gene expression data which is other than said particular gene expression data.

In one aspect, the reference standard was obtained by arranging the expression intensities of the genes of each of the biological samples in ascending or descending order and calculating the arithmetic mean across each position in said ordering, the resulting set of mean values constituting the reference standard.

In another aspect of the invention, a method of normalizing gene expression data obtained on a given microarray for a particular biological sample using later generation technology associated with said microarray, e.g., instrumentation such as fluidic stations, scanners, etc., is provided where reference standard gene expression data obtained for the same microarray on an earlier version of such technology is employed for such later generation normalization. The normalized data become equivalent to the data obtained from the use of the earlier generation of instrument. For example, the normalized data can then be analyzed and interpreted according to the results and methods established by the use of the data collected from the earlier generation of instrument.

A reliable reference standard has been generated which can be used for quantile normalization of gene expression profiling data, e.g., generated from Affymetrix HG U133A GeneChips for nasopharyngeal carcinomas (NPCs) or other types of tumors. This reference standard can be used to reduce variations within the same laboratory and/or between laboratories using the same microarray technology.

The establishment of such a universal reference standard, according to the invention, allows the direct normalization of the Affymetrix HG U133A gene expression profiling data from the case of NPC or other type(s) of tumors for clinical application.

This invention relates to generation and use of a universal reference standard, e.g., for normalization of nasopharyngeal carcinoma and other microarray data, e.g., from Affymetrix HG U133A GeneChip™. The present inventions in some aspects are also directed to a universal reference standard for quantile normalization of tumor microarray data, e.g., from Affymetrix HG U133A GeneChips™, e.g., so that gene expression profiling data of NPC's, other types of tumors, and other disease related data can be analyzed for diagnoses, management of patients, etc.

The present invention includes a universal reference standard for quantile normalization of microarray platforms, e.g., Affymetrix HG U133A GeneChip™ gene expression profiling microarray data. In one preferred embodiment, this reference standard was created by using a data set including 164 primary NPCs, 15 normal nasopharyngeal tissues, and 23 metastatic NPCs. Inclusion of additional samples did not further improve the resultant reference standard. This reference standard is applicable to gene expression intensities expressed by a wide range of genes and can be applied to normalize all Affymetrix U133A GeneChip gene expression profiling data of NPC and other types of tumors. Thus, the established reference standard is universal for all types of tumors. The microarray data normalized to the universal reference standard can then be analyzed for prediction of clinical and biological outcomes of tumors for prognostication, risk assessment, treatment optimization, and the like.

The present invention includes a reference database of 202 tissue samples and a method for quantile normalization of gene expression profiling data of NPCs, other types of tumors (e.g. liver cancer and others), and in general, for normalization of any type of expression data produced by microarrays, such as Affymetrix HG U133A GeneChip™, e.g., data on disease states in general.

### BRIEF DESCRIPTION OF THE DRAWINGS

Various features and attendant advantages of the present invention will be more fully appreciated as the same becomes better understood when considered in conjunction with the accompanying drawings, in which like reference characters designate the same or similar parts throughout the several views, and wherein:

FIG. 1. shows the correlation between reference standards established by using different numbers and types of tissue samples. The reference standards for quantile normalization were generated using microarray data from 23 metastatic nasopharyngeal carcinomas (NPCs) (standard 1), 15 normal nasopharyngeal tissues (standard 2), and 164 primary NPC tissues (standard 3), respectively. The fourth reference standard was constructed by combining microarray data of all tissues (n=202) as mentioned. The microarray data were scaled to a trimmed mean of 500 using Affynetrix MAS 5.0 software. The gene expression intensities were logarithm transformed at a base of 2 and arranged in ascending order. The intensities of gene expression of the same rank in two reference standards were correlated with each other. There are six correlations for all four reference standards. Pearson linear correlation analysis was performed using R software v.2.0.0 from the R Foundation for Statistical computing. The correlation coefficient of each regression is shown in each panel. The P value for each correlation is less than 0.0001.

FIG. 2. shows the correlation of the reference standards established with 202 and 284 tissue samples. To demonstrate that addition of more tissue samples does not further improve the reference standard (standard 4) established by using all 202 tissue samples as mentioned in FIG. 1, microarray data from 82 additional NPC samples were added to the original 202 different tissue samples, and constructed another reference standard (standard 5). A similar correlation study as described in FIG. 1 was conducted. The result shows near perfect Pearson linear correlation (r=0.9999, p<0.0001).

FIG. 3 shows a correlation study of gene expression before and after quantile normalization for ten randomly selected nasopharyngeal carcinomas. The gene expression profiling data were determined by using Affymetrix HG U133A GeneChips. The expression intensity of each gene was normalized to the reference standard 4. The Pearson linear correlation of expression intensity of each gene before and after quantile normalization was conducted. Pearson linear correlation analysis showed highly significant correlation (r>0.999 and p<0.0001). The results indicate that quantile normalization did not distort the gene expression intensities. All gene expression intensity was expressed as the logarithm of the intensity at a base of 2.

FIG. 4 shows a correlation study of gene expression before and after quantile normalization to the universal reference standard (reference standard 4) for ten randomly selected liver cancers (hepatocellular carcinomas). The gene expression intensities of ten liver cancers were measured using Affymetrix HG U133A GeneChips. The expression intensity of each gene was normalized to the reference standard 4. The correlation of expression intensity of each gene before and after quantile normalization was conducted. Pearson linear correlation analysis showed highly significant correlation (r>0.999 and p<0.0001). The results indicate that gene expression profiling data of different types of tumors can be normalized to the reference standard 4 for subsequent analyses. All gene expression intensity was expressed as the logarithm of the intensity at a base of 2.

FIG. 5 shows a correlation of gene expression data normalized to a PM probe set reference standard and to an Affymetrix MAS 5.0 reference standard. The quantile. normalization reference standards were generated using the data set consisting of four NPC samples and one normal nasopharyngeal tissue. One reference standard was generated based on Affymetrix PM probe set data (PM standard) and the other was generated based on Affymetrix MAS 5.0 gene expression data (MAS standard). For the PM probe set data, the gene expression intensities were retrieved using RMAExpress 2.0 software. For the Affymetrix MAS 5.0 gene expression data, the data were obtained by using MAS 5.0 software. Both sets of gene expression data were quantile normalized to the respective reference standards and correlated with each other for each sample. The results for the first sample (shown in FIG. 5) indicate a proportional correlation between the two sets of normalized data. Nevertheless, gene expression data normalized to the PM reference standard showed compression in the low expression intensity region.

FIG. 6 shows a correlation of gene expression data normalized to a PM probe set reference standard and to an Affymetrix MAS 5.0 reference standard as discussed for FIG. 5. FIG. 6 shows the results of the three NPC samples and one normal nasopharyngeal tissue not shown in FIG. 5. The results of these remaining four cases are similar to the results of the first case shown in FIG. 5.

FIG. 7 shows a correlation of intensities of gene expression obtained from the same NPC samples on U133A GeneChips processed with different Affymetrix fluidic stations and scanners. The x axis represents the intensity of each gene measured by the use of new GeneChip Fluidic Station 450 and Scanner 3000, and the y axis represents the intensity of each gene measured by the use of old GeneChip Fluidic Station 400 and Scan Array 2500 scanner. Expression intensities of all genes for each sample were obtained by MAS 5.0 software and correlated with each other. Linear regression analysis was performed using S-plus 6 software (Insightful Corp.). Six different NPC samples were studied. All solid regression lines have slopes less than 1 (FIG. 7), and are between 0.775 and 0.945 (Table 2). P values for linear regression were <0.001 for all samples. As shown in this figure, the gene expression intensities were higher for the GeneChips processed with the new generation of fluidic station and microarray scanner.

FIG. 8 shows a correlation of intensities of gene expression obtained from the same NPC samples on U133A GeneChips processed with different Affymetrix fluidic stations and scanners. All gene expression intensities studied in FIG. 7 were normalized to the same universal reference standard following the method of quantile normalization as detailed above, e.g., in Examples 1-6. The x axis represents the intensity of each gene measured by the use of new GeneChip Fluidic Station 450 and Scanner 3000, and the y axis represents the intensity of each gene measured by the use of old GeneChip Fluidic Station 400 and Scan Array 2500 scanner. Linear regression analysis was performed using S-plus 6 software. The results show highly significant linear correlation with slopes close to 1 (FIG. 8) and between 0.989 and 0.995 (Table 2). P values for linear regression were <0.001 for all samples. The regression lines are essentially superimposed with the diagonal lines.

Thus, this invention relates to a method of generating a set of gene expression data capable of providing a reference standard for normalization of any gene expression data, preferably, using the quantile normalization method, comprising measuring expression data, e.g., using a microarray platform, for a plurality of genes on each of a number of biological, e.g., tissue samples, including normal tissue, tumorous tissue, etc., sorting the expression data according to expression degree, (e.g. intensity), e.g., in ascending or descending order, calculating an average value for each such ordered expression degree (e.g., intensity) of each gene across all of said number of samples (e.g., calculating an arithmetic mean for each expression degree across all of said samples), to provide a reference standard for normalization, the number of said samples being sufficient that repeating said method with additional biological samples does not significantly improve the quality of normalization provided by the resultant reference data set, or does not provide a set of such average expression values significantly different from those calculated without the additional samples. For this invention, the term “gene expression data” encompasses any sort of gene-related sequence, e.g., probes, oligos, RNA-based, DNA-based, other nucleic acid-based by hybridization sequence, etc. Typically, the number of genes in a mircoarray will preferably be essentially all those available at a given time, e.g., for humans (or other species of interest), typically one, five, ten, twenty, thirty, forty, fifty, etc. thousand or more, as contained in commercial microarrays.

Typically, the number of biological samples included will be at least two, e.g., five or more, ten or more, fifty or more, one hundred or more, etc. The biological samples can include only normal tissue, only abnormal tissue, e.g., diseased tissue, e.g., cancerous tissue, e.g., containing tumors, normal blood, abnormal blood, normal cells, leukemic, etc. The disease tissue can all be of the same type and stage, e.g., all NPC, all of primary type or all of metastatic type, or, instead of NPC tissue, cancerous liver, kidney, colon, lung etc. tissue can be used, again of varying or of the same stage and type; or samples having different types of diseases, e.g., different types of cancers; or, preferably, including both diseased and normal biological samples, e.g., as exemplified below.

In another aspect of this invention, the data sets from which reference standards suitable for normalization can be prepared can be used in conjunction with preparation of reference standards (a set of data which can be used for normalization of gene expression data), not only for use with the tissue types included in the data set per se or with the microarray type used to generate the raw gene expression data per se, but also can be applied to normalization of any other biological sample type generated on the same type of microarray system. Such features are also exemplified below.

This invention also relates to both the data sets from which reference standards can be calculated and also the reference standards themselves, both prepared in accordance with this invention.

The invention in another aspect also relates to a method of normalizing a set of gene expression data comprising quantile normalizing said data set using as a reference standard, the reference standard in accordance with this invention.

The following discussion is framed in terms of currently available gene expression profile microarrays. Using the guidance of this application, all aspects of the invention can be applied to any other such microarray and/or gene expression data, including updated versions of the microarrays utilized herein, any other microarray type, etc. For instance, in one type of updating procedure, stored embodiments of tissue samples used to prepare a given data set and reference standard base thereon can be reanalyzed as described herein, using the updated version of a particular nucleic acid microarray, e.g., containing additional genes, oligos, etc. Certain aspects of this invention are depicted schematically in diagrams A and B. 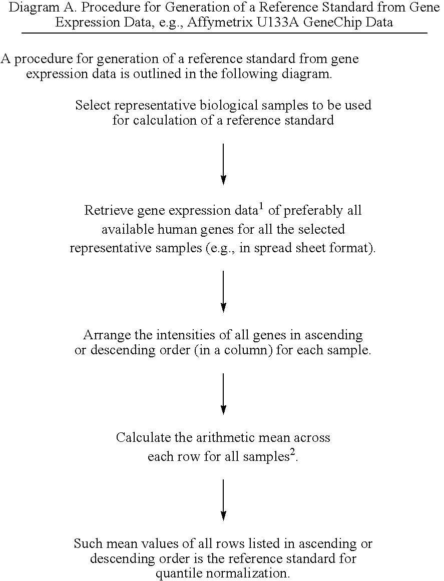
1: Affymetrix U133A GeneChip data is exemplary. Such data for each gene can be obtained through the use of conventional microarray software, e.g, MAS 5.0 software of Affymetrix, with or without logarithmic transformation. As another example, Affymetrix data for each perfect match (PM) probe also can be used.
2. After sorting the intensity values of all genes for each sample, yᵢ(j) is defined as the intensity value for the jth order in the ith sample,

n is defined as the total number of samples and Gj as the mean intensity value for jth order in the reference standard. The value of Gj is calculated according to the following formula:

$${G}_{j} = \frac{{\sum }_{i = 1}^{n} {y}_{i ( j )}}{n}$$

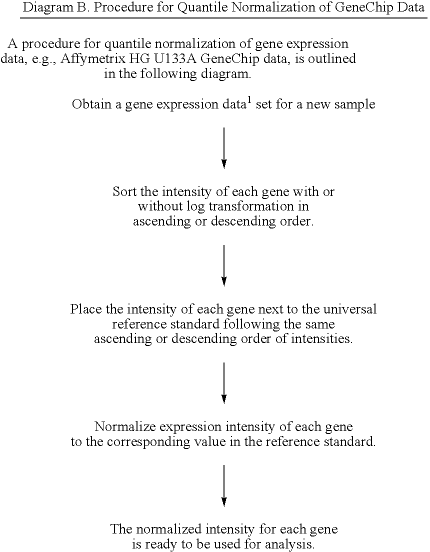

1: For example, Affymetrix HG U133A GeneChip data can be used, with or without logarithmic transformation according to how the reference standard of this invention is derived.

The preferred method for normalizing a particular gene expression data set is quantile normalization such as disclosed in Bolstad et al., Bioinformatics 19:185-193, 2003, whose disclosure is incorporated fully by reference herein. Thus, after intensity sorting of the new data set versus the reference standard according to Diagram B, the intensity in a given row of the reference standard is substituted for that of the new data set in the same row. This simple substitution is feasible because of the essential inflexibility of the reference standards for a given microarray type. In principle, any technique for quantile normalization can be utilized. Similarly, any normalization method can also be used, e.g., any of those disclosed in the Bolstad et al, Park et al, Benito et al, and Sorlie et al references discussed above, or others, e.g., cyclic losses, contrast based, scaling and other linear methods, non-linear methods, global, intensity-dependent, etc

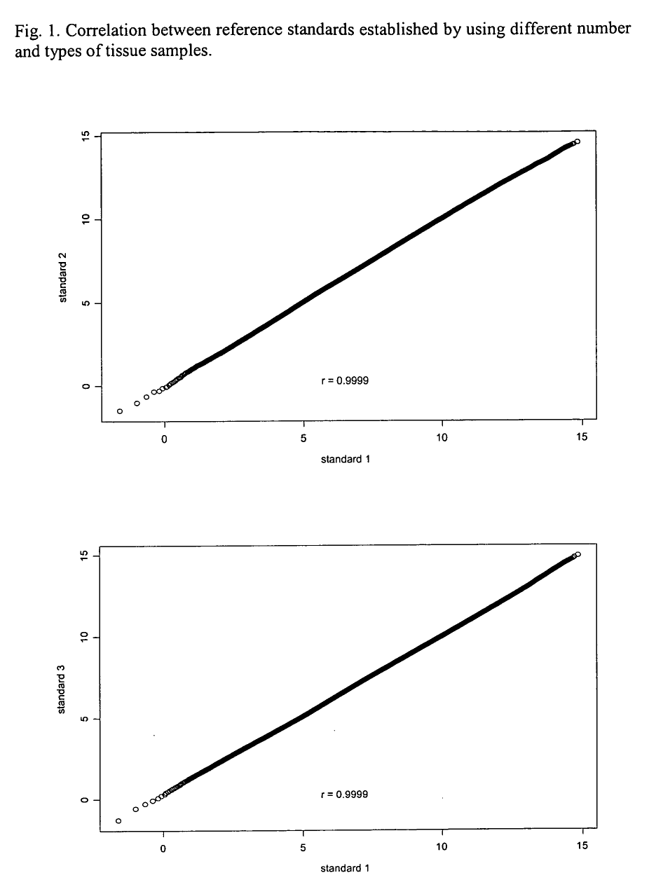

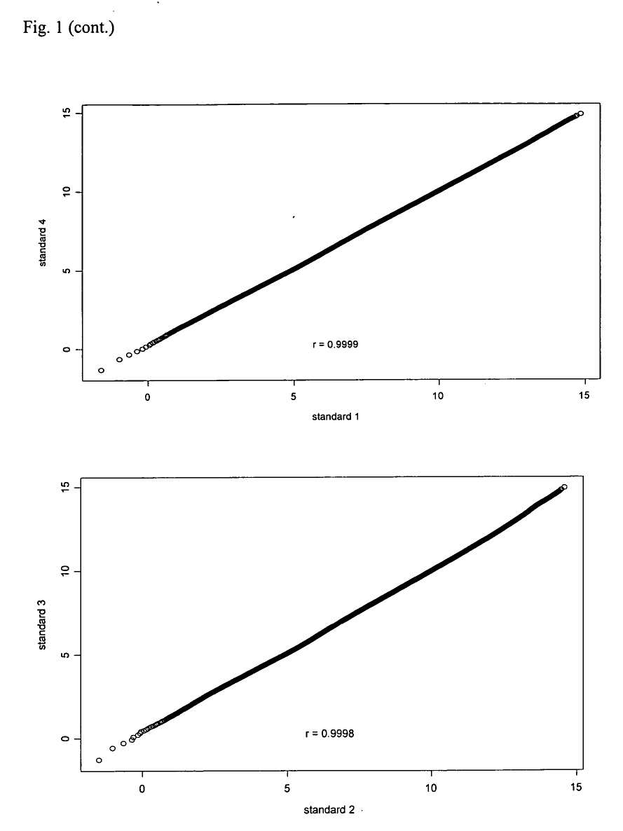

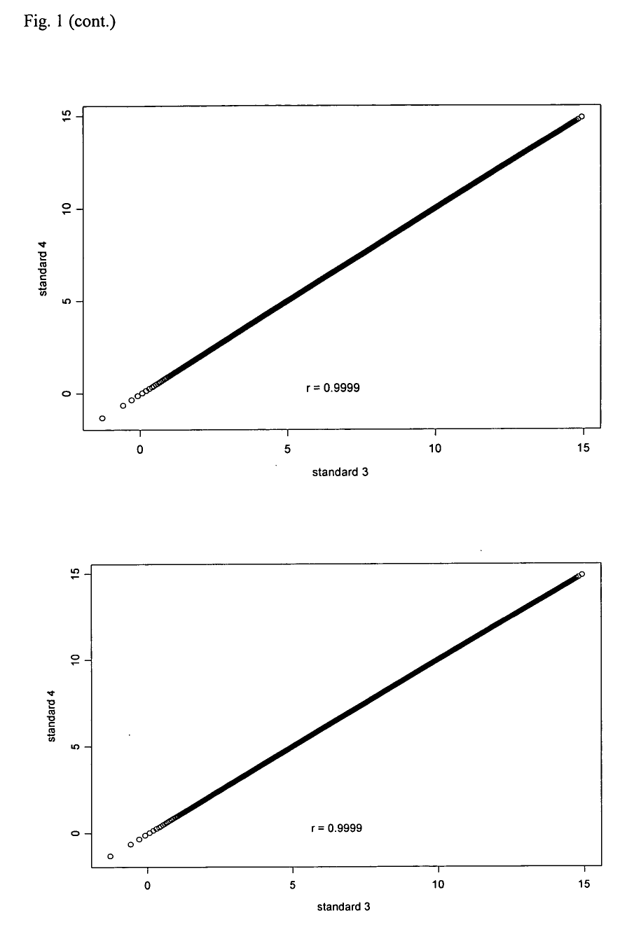

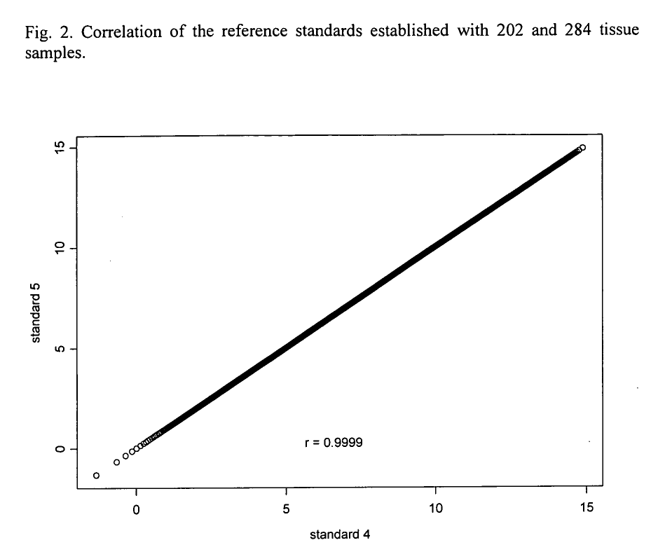

Thus, the present invention provides a universal reference standard for normalizing gene expression data. It is applicable to any tissue, normal or diseased or otherwise abnormal, including cancerous (tumorous) tissue, and to any kind of gene expression data set. For instance, the method is applicable to all human genes that are present on the current version of Affymetrix HG-U133A GeneChip™. In a preferred embodiment, the universal reference standard is derived from the gene expression profiling data of 164 nasopharyngeal carcinomas, 15 normal nasopharyngeal tissues, and 23 metastatic nasopharyngeal carcinomas as shown in the examples. Also generated was a series of reference standards using only nasopharyngeal carcinomas (n=164), normal nasopharyngeal tissues (n=15), or metastatic nasopharyngeal carcinomas (n-23). A Pearson linear correlation study was conducted between different, reference standards (R Software v.2.0.0, The R Foundation for Statistical Computing). All reference standards correlated with each other in near perfect linearity and are essentially identical (FIG. 1). The finding suggests that the reference standards generated by us for quantile normalization are the same and can not be further improved by inclusion of additional tissue samples. To confirm this conclusion, another reference standard was generated by inclusion of 82 additional NPC samples to the original 202 tissue samples (164 primary NPCs, 15 normal nasopharyngeal tissues, and 23 metastatic NPCs). The new reference standard generated from a total of 284 samples was correlated with the reference standard generated form the original 202 tissue samples using Pearson linear correlation analysis. The results showed that both reference standards are essentially identical (FIG. 2). Thus, all reference standards essentially are the same. The reference standard derived from the original 202 samples is used herein as the universal reference standard.

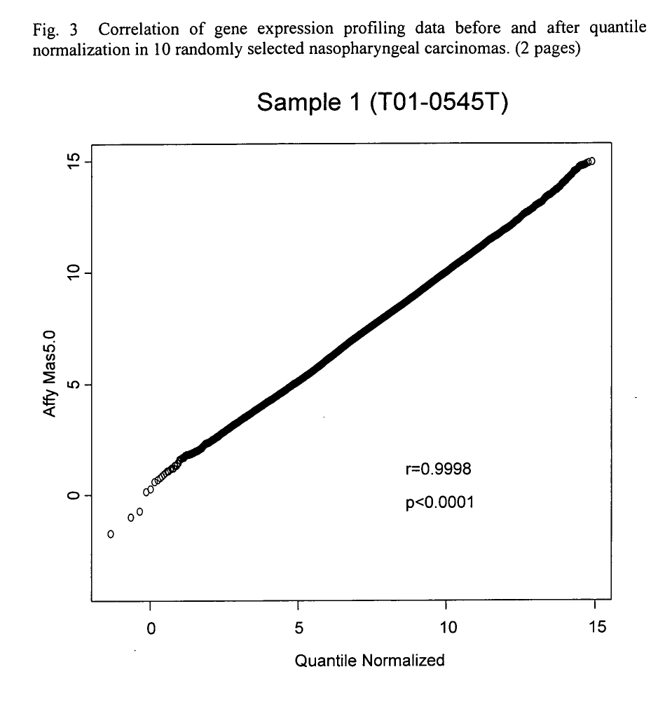

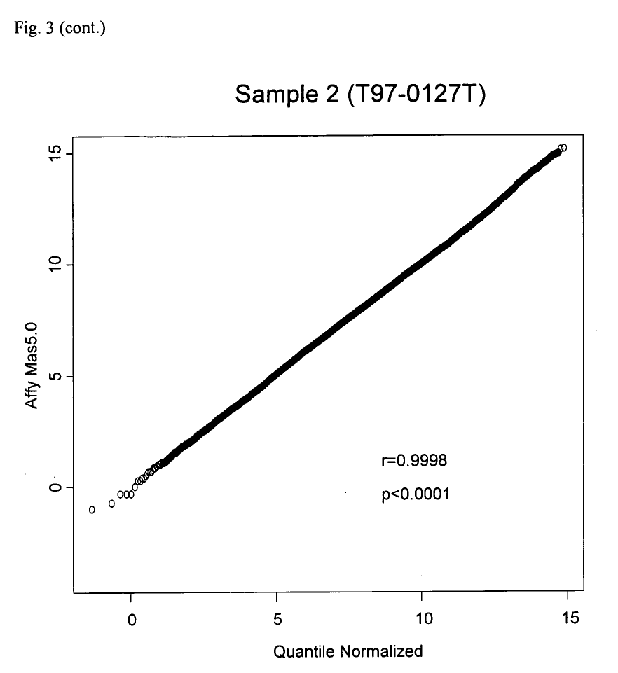

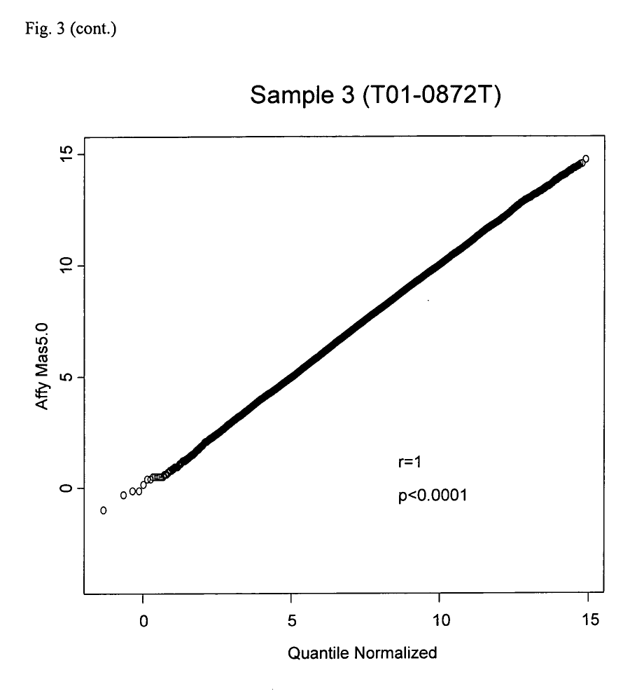

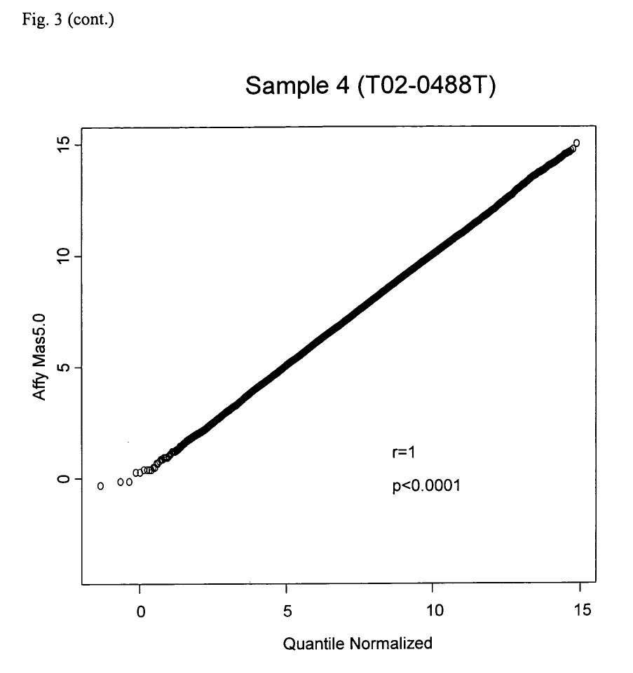

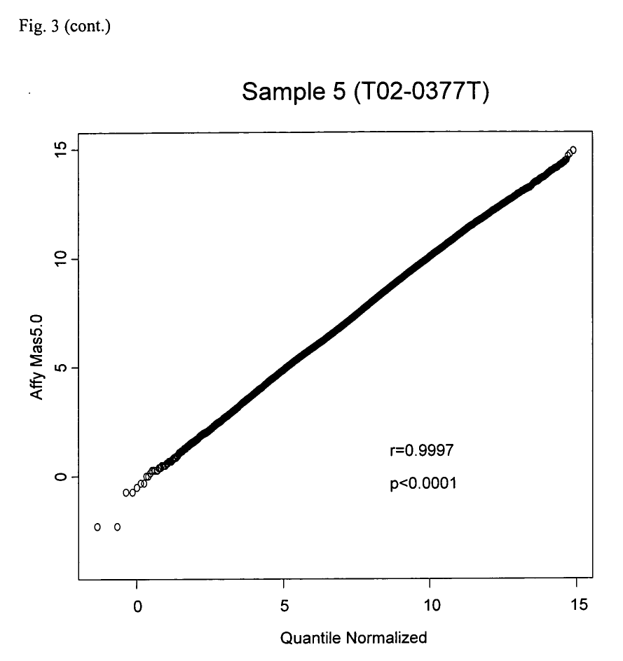

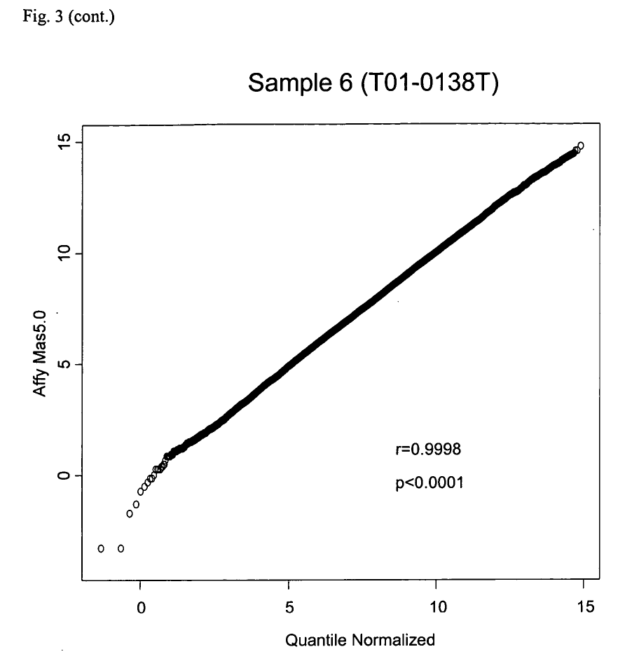

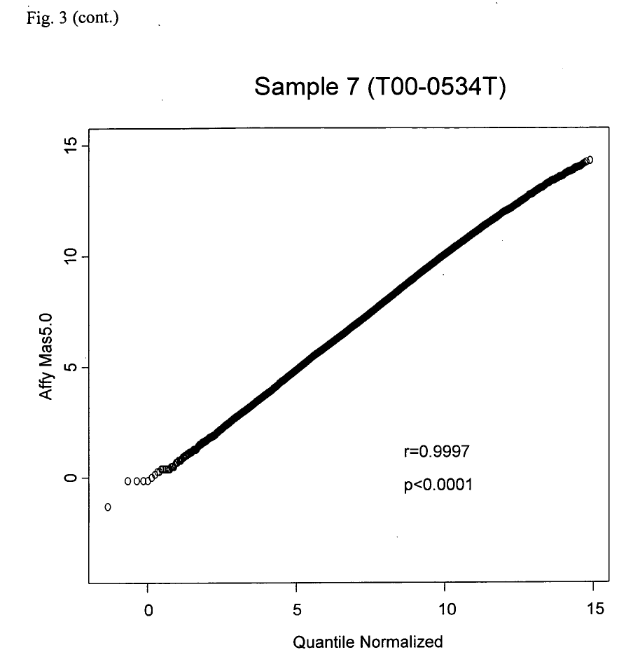

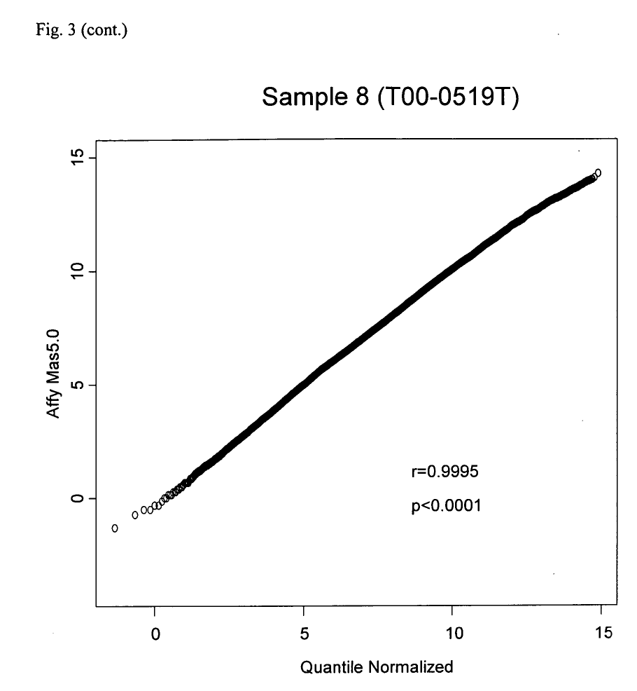

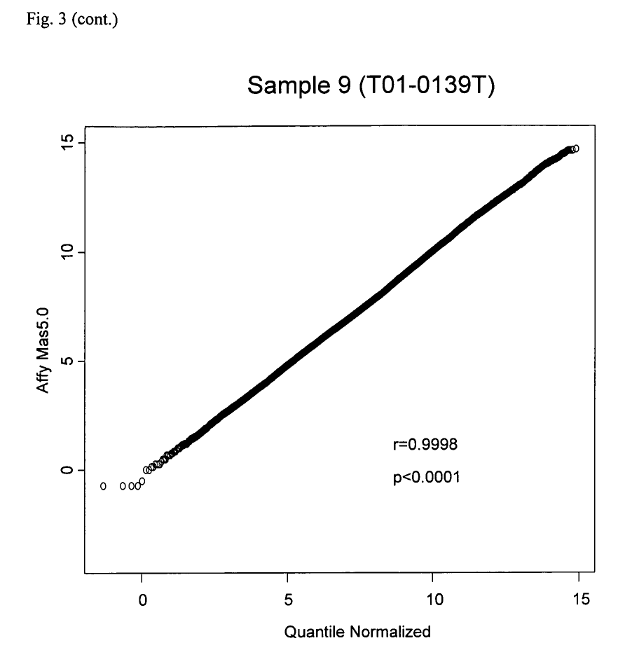

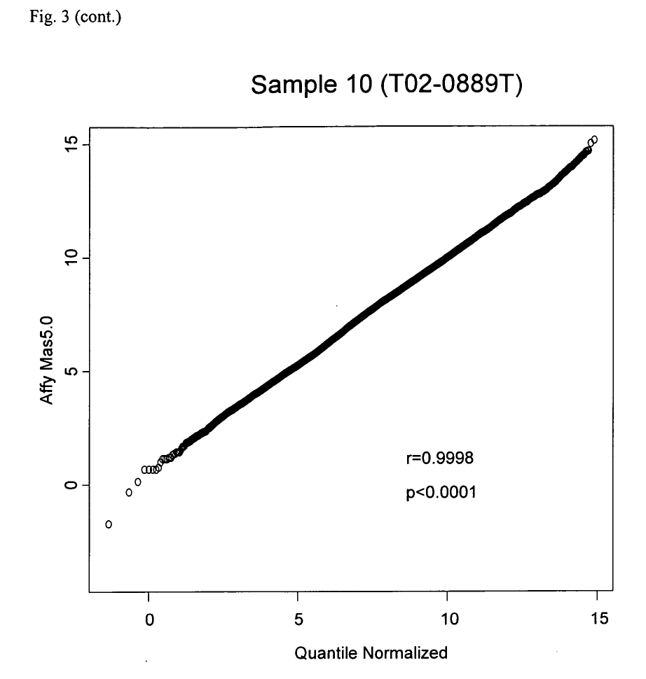

A study was conducted to establish that this universal reference standard can be used for quantile normalization of NPC gene expression profiling data generated from the same microarray platform used to generate the standard, i.e., Affymetrix HG-U133A GeneChips™. The Affymetrix HG U133A gene expression intensity of each gene before and after quantile normalization was correlated to the universal reference standard in ten randomly selected NPC samples using Pearson linear correlation analysis (FIG. 3). The results show highly significant linear correlation and show that the universal reference standard can be used for quantile normalization of NPC gene expression profiling data generated by the same microarray type Affymetrix HG-U133A GeneChips™, e.g., to provide reliable predictions of disease outcomes and/or progression from gene expression data.

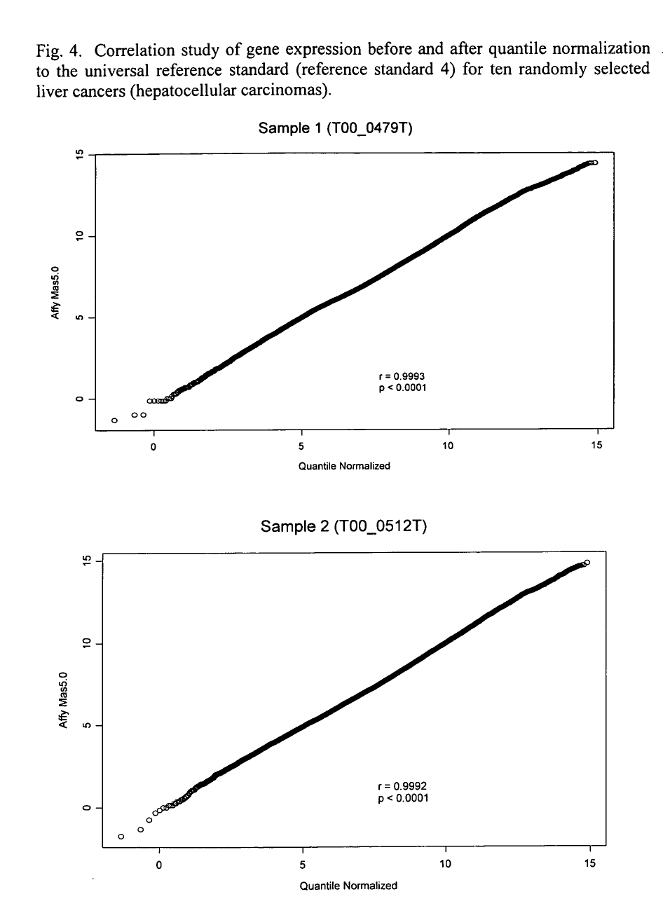

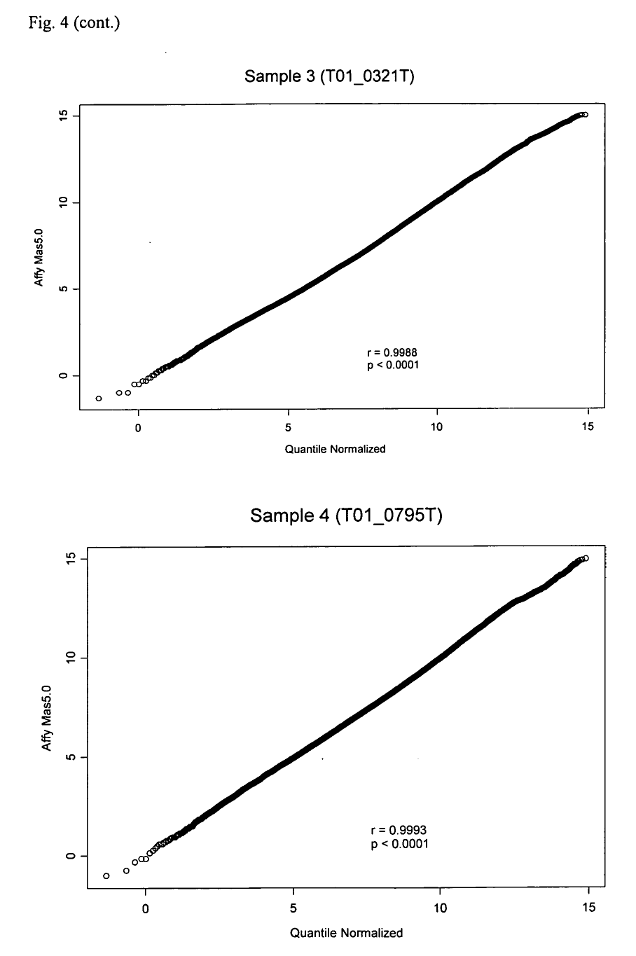

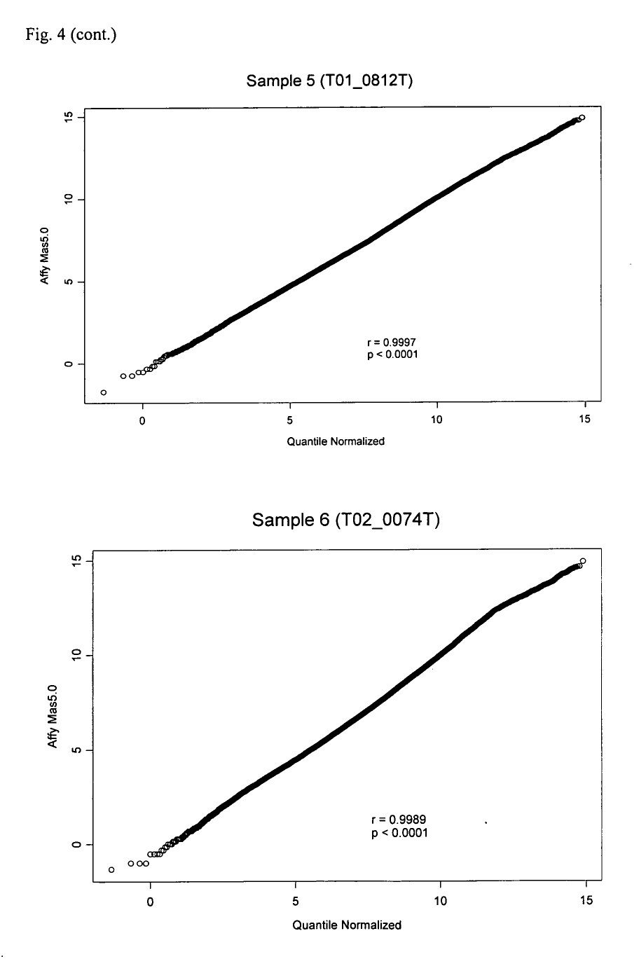

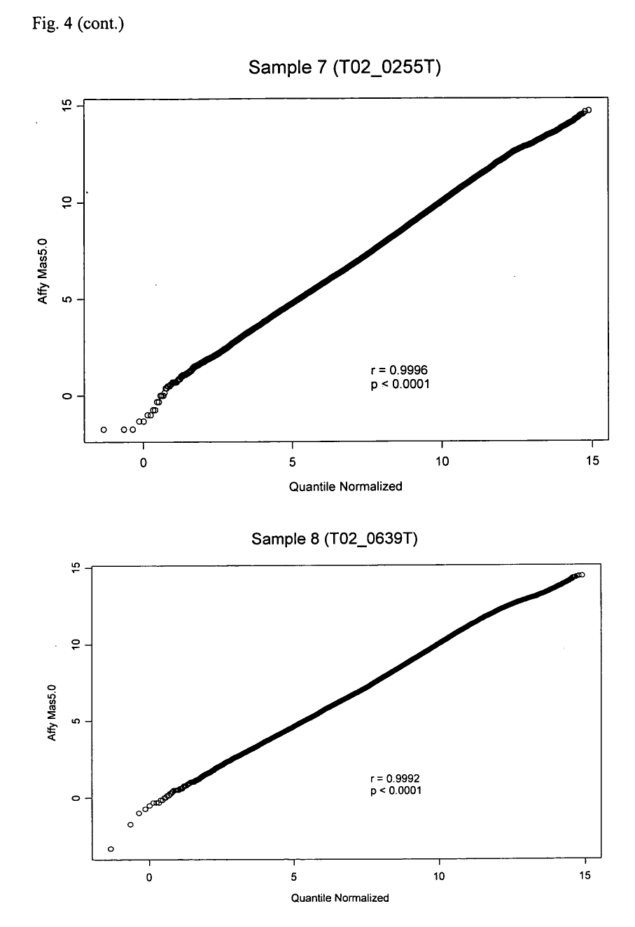

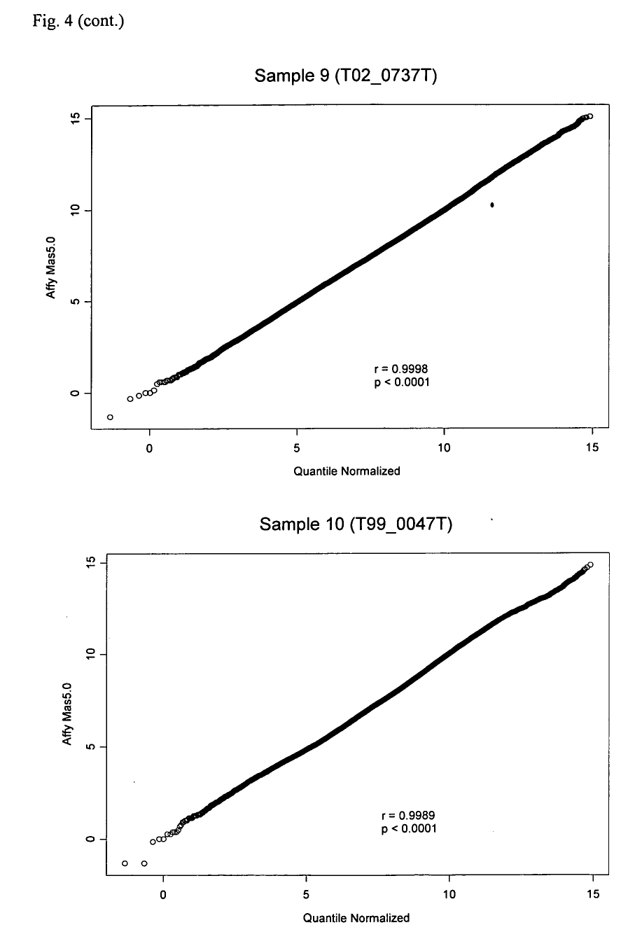

It was also demonstrated that the universal reference standard could be used for quantile normalization of gene expression profiling data generated by the same microarray type (here Affymetrix HG-U133A GeneChips™) for different types of tumor samples. A study was conducted on ten randomly selected liver cancers. The gene expression profiling data of these ten liver cancers were collected by using Affymetrix HG U133A GeneChips. The data were normalized to the universal reference standard mentioned above. When the normalized gene expression profiling data were correlated with the gene expression intensities without normalization by Pearson linear correlation analysis, the results showed high degrees of linear correlation of all genes for all ten cases (FIG. 4). This finding shows that the universal reference standard constructed in accordance with this invention can be applied to normalize different types of tumors, and is truly universal. This universal reference standard as well as from other reference standards discussed herein, with and without logarithm transformation, are contained in the file: “Reference Standards.txt” in the appended CD.

It was also demonstrated that the universal reference standard could be used for quantile normalization of gene expression profiling data generated by the same microarray type (here Affymetrix HG-U133A GeneChips™) using newer generations of technology, here new GeneChip Fluidics Station 450 and GeneChip Scanner 3000 (by Affymetrix) to replace the GeneChip Fluidics Station 400 and the GeneArray 2500 scanner (by Affymetrix) used in the experiments described above and Examples 1-6. Such instrument improvements are made, for example, in view of the increasing importance to the use of DNA and oligonucleotide microarrays for RNA transcripts (gene-expression) profiling for diagnosis and prognostication of diseases, discovery of drugable targets, adjustment of therapy according to individual risk, etc. Thus, like all technologies the reagents, instruments and the like for DNA and oligonucleotide microarrays are constantly evolving. Consequently, the question of how most efficiently to analyze and interpret microarray data generated from newer generations of technology on the basis of results derived from earlier generations of technology becomes an important issue.

For example, the intensities of RNA transcripts measured by the new fluidic station and the new scanner are stronger than those measured by the previous generation of instruments. Results generated by the new instrument have less background noise and higher signal intensity. Consequently, data obtained from the new instrument often can not be directly analyzed according to methods established on the basis of results generated from the use of previous generations of instrument. In order to avoid repeating the same study for each new generation of instrument, it would be advantageous to be able to normalize the data collected from new instruments based on a reference standard derived from the previous version of instrument to produce data equivalently and reliably useful to that generated on the older version. In order to address this problem, a series of experiments has been performed to provide a solution to this problem (Examples 7-10).

Without further elaboration, it is believed that one skilled in the art can, using the preceding description, utilize the present invention to its fullest extent. The following preferred specific embodiments are, therefore, to be construed as merely illustrative, and not limitative of the remainder of the disclosure in any way whatsoever.

In the foregoing and in the following examples, all temperatures are set forth uncorrected in degrees Celsius and, all parts and percentages are by weight, unless otherwise indicated.

### EXAMPLE 1

a) Determination of Gene Expression Profiling Data from Tissues Using Affymetrix U-133A GeneChips™

Patients and biopsy specimens: The gene expression data were collected from tissue samples collected from fresh biopsies or surgical resections at the Koo Foundation Sun Yat-Sen Cancer Center (KF-SYSCC) in Taipei, Taiwan. They were collected and banked between 1995-2003. The samples include biopsies of primary nasopharyngeal carcinomas, normal nasopharyngeal tissues, metastatic nasopharyngeal carcinomas and liver cancer. Samples were collected according to a protocol approved by the KF-SYSCC Institutional Review Board. These samples represent a heterogeneous population, and were randomly selected based on the quality and the quantity of the extracted mRNAs.

RNA extraction and purification protocol. Approximately, 20 to 30 mg of frozen tumor tissue was quickly put in 1 ml of Trizol™ reagent in a 2 ml polypropylene tube. The tissue was homogenized using a PowerGen 125 homogenizer (Fisher Scientific) for 20 to 40 seconds and tissue lysate was transferred into a PhaseLock gel-heavy (Eppendorf) incubated 5 minute at room temp according to the instruction of the manufacturer. Chloroform (0.2 ml for each ml of Trizol) was added. The tube was capped, shaken vigorously for 15 seconds and incubated at room temperature for 5 minutes. The incubation mixture was centrifuged at 9,300 g for 10 minutes at 4° C. The aqueous phase on top of gel was harvested into a sterile 1.5 ml microfuge tube. After addition of 0.5 ml isopropyl alcohol and 50 microgram glycogen, the tube was mixed with gentle vortexing for a few seconds and incubated at room temperature for 10 min. Thereafter, the tube was microfuged at 9,300 g for 10 minutes at 4° C. The supernatant was removed and the pellet was saved. One ml of 75% ethanol pre-chilled at −20° C. was added onto the RNA pellet. The tube was gently mixed and microfuged at 9,300 g for 5 minutes at 4° C. The supernatant was removed using a pipettor and a RNAse free clean pipet tip. The tube was inverted on a piece of Kimwipe™ and dried for 1-2 minutes. The RNA pellet was dissolved in 100 microliter RNAse free water. RNA was further purified using the Qiagen RNeasy kit according to the instruction of the manufacturer. One microliter of RNA sample was diluted 60× with 59 microliter RNAse free water and measured for concentration and purity by absorbance at 260 nm and 280 nm. The quality of the purified total RNA was also assessed with an Agilent Lab-on-a-Chip 2100 Bioanalyzer. 200 ng of RNA was run on an Agilent BioAnalyzer RNA Labchip. This instrument estimates the concentration of RNA and calculates the amount of 18S and 28S rRNA in each sample. Quality total RNA samples have 28S/18S ratios around 1.6. Poor quality RNA samples have reduced 28S/18S ratios and smaller size RNA fractions. The quality of RNA also can be assessed with a software provided by the manufacturer of Agilent 2100 Bioanalyzer for RNA integrity number (RIN). The acceptable RIN number is ≧7. Only RNA samples with RIN≧7 were used in these examples. The excess of RNA was precipitated with 0.7M ammonium acetate and 70% alcohol and stored at −70° C. until ready for Affymetrix GeneChip analysis.

GeneChip Microarray Analysis:

Approximately 20 micrograms of tumor total RNA with RIN≧7 and precipitated in ammonium acetate and alcohol were removed and microfuged at 9,300 G for 10 minutes at 4° C. The RNA pellet was washed once with 0.5 ml 80% alcohol pre-chilled at −20° C. After microfuge and removal of alcohol, the RNA pellet was air dried and dissolved in 11 microliter RNAse free water. One microliter of RNA was diluted 6033 and measured for RNA concentration by OD 260 nm. Hybridization targets were prepared from total RNA and hybridized to Affymetrix HG U133A GeneChip microarrays according to the Affymetrix protocols.

The procedures are described in the following:

i) Synthesis of cDNA

Combine 8 micrograms of total RNA with the First Strand Synthesis reagents from Invitrogen kit (dNTPs, Superscript Reverse Transcriptase, buffer, DTT) according to the instructions of the manufacturer. Add an oIigo(dT)24 primer containing T7 promoter sequence. Incubate at about 42° C. for about 1 hour to generate the first strand cDNA. Add Second Strand Synthesis reagents (buffer, dNTP, DNA ligase, DNA Polymerase I, RNase H) according to the instructions. Incubate at 16° C. for about 2 hours to degrade RNA and synthesize double-stranded cDNA.

ii) Clean Double-Stranded cDNA

Double stranded cDNA is purified with a GeneChip Sample cleanup Module (Affymetrix) according to the instructions.

iii) Synthesize Biotin-Labeled cRNA

Combine cDNA with biotin-labeled ribonucleotides and in vitro transcription reagents from EnzoDiagnostics kit (buffer, DTT, RNase Inhibitor, T7 RNA Polymerase). The incorporated biotin-nucleotides will be used to bind a fluorescent dye conjugated to streptavidin. Incubation is performed at 37° C. for about 5-6 hours. Store one microliter of cRNA in freezer for analysis of cRNA size by Agilent 2100 Bioanalyzer. Continue protocol with remaining cRNA.

iv) Clean and Quantify cRNA

Purify the cRNA sample using the GeneChip Sample Cleanup module (Affymetrix). Wash column with ethanol-containing solutions. Remove excess ethanol with multiple spins followed by room temperature incubation, and elute the cRNA with water according to the instructions of the manufacturer.

v) Determine Quantity of cRNA

Good hybridization signals require approximately 15 micrograms of labeled targets. Spectrophotometer readings can be used to determine the concentration of each cRNA sample and the volume necessary for the hybridization cocktail. Determine absorbance at 260 nm and 280 nm wavelengths. Quality samples usually yield>20 μg cRNA and have 260/280 ratios around 2.0.

vi) Chemical Fragmentation of RNA

Suspend all cRNA probes in 40 microliter of fragmentation buffer prepared according to the instructions from Affymetrix. The incubation is performed at 94° C. for about 35 minutes. The fragmented cRNA can be frozen at −80° C. until hybridization with probes in the Affymtetrix HG U133 A GeneChip.

vii) Confirm Size of Fragmented cRNA

Fragmentation of cRNA targets results in better hybridization to oligonucleotide microarrays. Run about 1 microliter (500 ng) of fragmented cRNA and non-fragmented cRNA on a RNA Labchip using an Agilent BioAnalyzer 2100. This assay determines the size of an RNA population relative to known markers based on capillary electrophoresis. Quality probes contain a mixture of cRNA fragments less than 200 bases. If necessary, probes with large cRNA fragments are incubated at about 94° C. and analyzed again.

viii) Hybridize Fragmented cRNA to Microarray

Fifteen micrograms of fragmented cRNA adjusted for its quantity according to the instructions of Affymetrix is combined with hybridization buffer (27 mM MES, 0.885M NaCl, 20 mM EDTA, 0.01% Tween 20, 0.1 mg/ml Herring Sperm DNA, 0.5 mg/ml acetylated bovine serum albumin). Include 50 pM OligoB2 (positive control; used to orient the array and the grid) and the Eukaryotic Hybridization Controls (1.5 pM BioB, 5 pM BioC, 25 pM BioD, 100 pM CreX; used to confirm the sensitivity of the hybridization). Denature the hybridization cocktail at about 99° C. for about 5 minutes and 45° C. for about 5 minutes. Transfer fragemented cRNA targets to an Affymetrix U133A GeneChip that has been pre-hybridized with hybridization buffer at 45° C. for 10 minutes according to the instruction of the manufacturer. The GeneChip was hybridized at 45° C. for at least 18 hours in a rotisserie oven.

ix) Wash and Stain Microarray

Remove hybridization cocktail from the U133A GeneChip cartridge and fill with non-stringent wash buffer. Wash the chip under a series of nonstringent and stringent conditions in an Affymetrix fluidic station. Stain array with a streptavidin phycoerythrin solution. Wash off excess stain. Signal is further amplified by incubating array with “biotinylated anti-streptavidin antibody solution” followed by staining with additional Streptavidin Phycoerythrin. Wash off excess stain. All the aforementioned steps were performed according to the instructions of Affymetrix.

x) Analyze GeneChip Test Array

Detect fluorescent signals on a processed chip using an Affymetrix GeneArray scanner. Calculate the background fluorescence and expression levels for controls using Affymetrix Microarray Analysis Suite (MAS) 5.0 software.

xi) Confirm Hybridization Quality Using Control Sequences on GeneChip Test Array

GeneChip arrays contain sets of PM and MM oligonucleotides complementary to the 5′ and 3′ regions of housekeeping genes. Good cRNA probes hybridize to both oligo sets from the same gene yielding 3′/5′ signal ratios<3.0. They also generate background fluorescence of less than 130 units and detect the presence of 100 pM CreX, 25 pM BioD, 5 pM BioC and often 1.5 pM BioB in the hybridization solution.

b) Conversion of U133A GeneChip Data File into Text Format

The gene expression data file derived from the Affymetrix scanner is saved as “dat” File. The “dat” file is converted to “cel” file. The intensity of the expression of each gene is then calculated, scaled to a trimmed mean of 500 and saved as “chp” file using Affymetrix MAS 5.0 software. The conversion of Affymetrix “chp” file to “txt” file was carried out by saving a “chp” file into a “txt” file format using Affymetrix MAS 5.0.

c) Retrieval of U133A GeneChip PM Probe Set Intensities

The gene-expression intensities of U133 A GeneChip PM probe sets are retrieved from Affymetrix “cel” file using RMAExpress 2.0 software without background adjustment and normalization. The retrieved data are saved in a text file for subsequent analysis.

### EXAMPLE 2

a) Generation of Reference Standards for Quantile Normalization

The gene expression data from Affymetrix HG U133A GeneChip with or without logarithm transformation are sorted in ascending or descending order for each sample and saved in spread sheet format. The arithmetic mean across each row is calculated for all samples. Arithmetic means of all rows listed in ascending or descending order constitute a reference standard which can be used for quantile normalization. Exemplary reference standards established by this invention are contained in the file: “Reference Standards.txt” in the appended CD.

b) Comparison and Correlation of Reference Standards Generated from Intensities of Perfect-Match (PM) Probe Sets of U133 A GeneChip and from Gene Expression Intensities Generated by Affymetrix MAS 5.0 Software.

To determine whether the gene expression data derived from PM probe sets without background adjustment or the gene expression data obtained from the Affymetrix MAS 5.0 software corrected with a scaling factor to a median of 500 are more suitable for generation of a reference standard, we randomly selected microarray data of four NPCs and one normal nasopharyngeal tissue. Two reference standards were generated according to the steps outlined in Diagram A. One reference standard was based on the expression data of PM probe sets (PM reference standard) and the other was based on the scaled intensity data generated by MAS 5.0 (MAS reference standard). All gene expression data were transformed with logarithm at a base of 2.

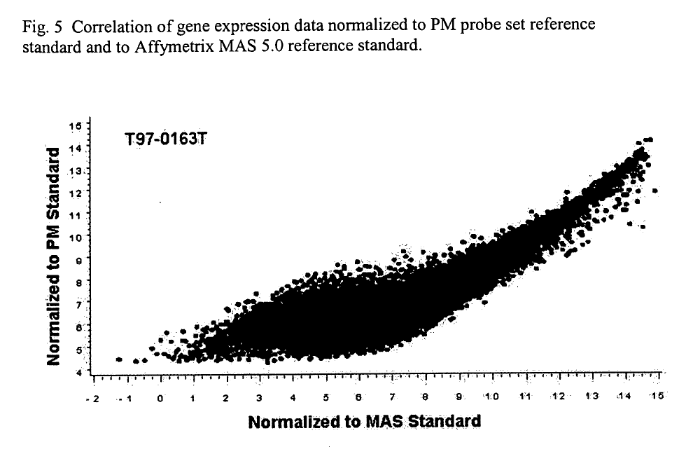

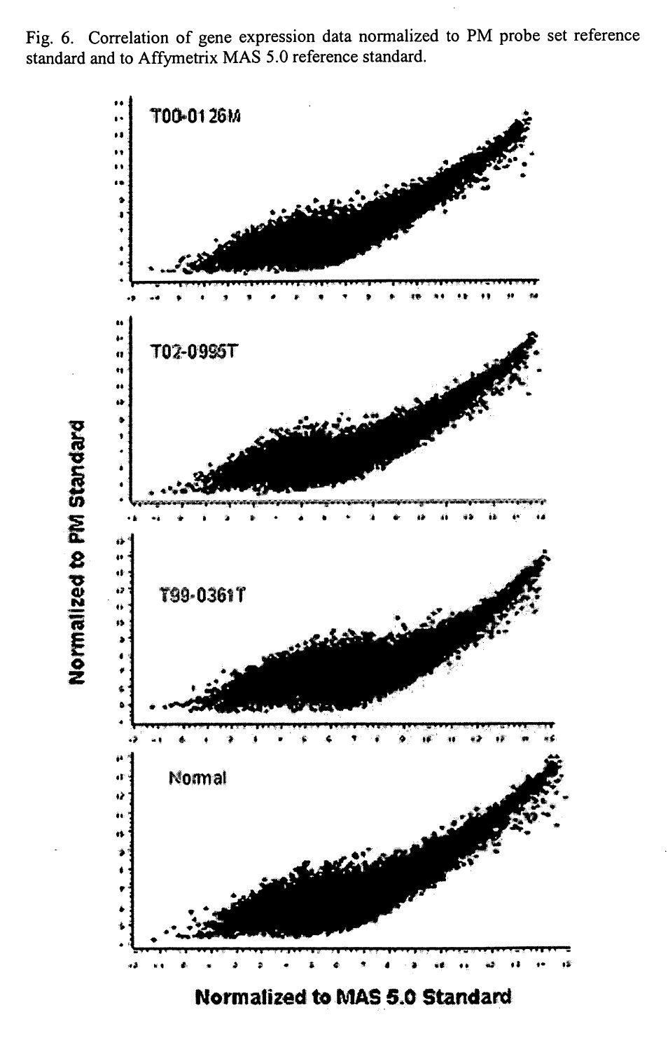

Quantile normalization as described in Diagram B was performed using the reference standard for each of the five NPC samples, separately. The normalized intensity of each was correlated with each other for each NPC sample. Representative correlation for the sample 1 is shown in FIG. 5. The result demonstrates a proportional correlation. The same proportional correlations were observed for the other three NPC samples and one normal nasopharyngeal tissue (FIG. 6). As shown in FIGS. 5 and 6, genes with low expression intensities were compressed when the gene expression data were normalized to the PM reference standard (Y axis of FIGS. 5 and 6). In contrast, there were greater differences among genes with low expression intensities when the gene expression data were normalized to the MAS reference standard (X axis of FIGS. 5 and 6). Therefore, it is more difficult to identify differentially expressed genes in the low intensity range when the PM reference standard is used for quantile normalization. The use of the MAS reference standard for quantile normalization of microarray data can avoid or ameliorate the problem of data compression. Nevertheless, both the PM and the MAS reference standards are applicable for quantile normalization.

### EXAMPLE 3

Effect of number and type of tissue samples on the establishment of a reference standard for quantile normalization. To determine how many samples are needed and whether different types of nasopharyngeal tissues are necessary for construction of a reference standard that will be used for quantile normalization of NPC gene expression profiling data. Four reference standards for quantile normaliztion were generated using microarray data from 23 metastatic NPCs, 15 normal nasopharyngeal tissues, and 164 primary NPCs. The first reference standard was based on 23 metastatic NPCs. The second was based on 15 normal nasopharyngeal tissues. The third was based on 164 primary NPCs. The fourth was based on all 202 tissues as described above. All reference standards were established by following the steps described in the Diagram A (See the file: “Reference Standards.txt” contained in the appended CD).

When all values in the reference standards are arranged in ascending or descending order and correlated with each other, all correlations are linear and highly significant (FIG. 1). The results shown in FIG. 1 indicate that all reference standards essentially are identical. Any of the four reference standards therefore can be used for quantile normalization of microarray data e.g., generated with Affymetrix HG U133A GeneChips.

To further demonstrate that the aforementioned reference standards are not further improved by inclusion of additional cases, we generated a fifth reference standard by adding microarray data of 82 new cases of NPCs to the database of the original 202 tissue samples (164 primary NPCs, 15 normal nasopharyngeal tissues, and 23 metaastatic NPCs). The fifth reference standard generated from a total of 284 tissue samples was correlated with the fourth reference standard generated form 202 tissue samples. This fifth reference standard is also contained in the appended CD: File=“Reference Standards.txt.” The results show that they are essentially identical (FIG. 2). Thus, the fourth reference standard generated from 202 tissue samples for quantile normalization not further improved by inclusion of microarray data of the additional 82 tissue samples

The results described above show that the reference standards generated from different numbers of samples essentially are the same. The fourth reference standard was generated by combining microarray data from 15 normal nasopharyngeal tissues, 164 primary NPCs and 23 metastatic NPCs. This reference standard is theoretically more representational. We use the fourth reference standard as a universal reference standard. This universal reference standard has been used for quantile normalization of NPC microarray data in subsequent studies, e.g., of gene expression signatures for prognostication and classification.

### EXAMPLE 4

Comparison and Correlation of Gene Expression Before and After Quantile Normalization for Ten Randomly Selected NPC Samples

To demonstrate the validity of using the universal reference standard for quantile normalization of Affymetrix HG U1333A GeneChip NPC microarray data, we conducted a correlation study on ten randomly selected NPC cases. The gene expression profiling data of these ten NPCs were determined by Affymetrix HG U133A GeneChips. The intensities of each gene were obtained from Affymetrix MAS 5.0 and normalized to the universal reference standard as described in Diagram B. The normalized intensity of each gene was correlated with the gene expression intensity derived from Affymetrix MAS 5.0. The results shown in FIG. 3 indicate that the normalized expression intensity of each gene is highly linearly correlated with the expression intensity of the same gene without normalization. These results demonstrate the validity of using the universal reference standard for quantile normalization of microarray data, e.g., from Affymetrix HG U133A GeneChips.

### EXAMPLE 5

Comparison and Correlation of Gene Expression Data Before and After Quantile Normalization for Ten Randomly Selected Liver Cancer Samples.

The primary purpose of this study was to demonstrate that the universal reference standard generated by the invention can be applied to normalize microarray data of tumors other than NPCs. For this study, gene expression profiling data of 10 liver cancers was obtained using Affymetrix HG U133A GeneChips. The intensities of each gene obtained from Affymetrix MAS 5.0 were normalized to the universal reference standard. The normalized intensity of each gene is then correlated with the intensity derived from Affymetrix MAS 5.0 without normalization. The results show highly significant linear correlation between the data before and after quantile normalization (FIG. 4). Therefore, the universal reference standard generated by the invention can be applied to different types of tumors (e.g. NPCs and liver cancers) and is indeed universal.

### EXAMPLE 6

Effect of Quantile Normalization on Reduction of Experimental and Technical Variations.

A purpose of quantile normalization is to reduce experimental and technical variations that may obscure results and interfere with data analysis of microarrays. Due to consistency of the Affymetrix HG U133A GeneChip and careful execution of the experimental procedures, variations in the microarray data are small. Consequently, the microarray data even without quantile normalization were highly correlated with the normalized data (FIGS. 3 and 4). Nevertheless, it is expected that quantile normalization should further reduce any slight variations. If such reduction of variations has occurred after quantile normalization, the degree of expression variation of each gene in the tested tissue samples should have been reduced. We therefore compared the degree of variation of the expression intensity of every gene with and without log₂ transformation for 246 primary NPC samples before and after quantile normalization. The Standard Deviations (SD) of the expression intensities of each gene before and after quantile normalization were calculated and were compared by a paired t test using SAS 9.1 software. The results showed that the standard deviation of each gene after quantile normalization was smaller than the standard deviation without quantile normalization (p<0.0001) (Table 1). The results of this comparative study have demonstrated that quantile normalization indeed can reduce variations.

### EXAMPLE 7

The design of a study to demonstrate that quantile normalization can be applied to correct microarray data differences generated from using different versions of fluidic stations and scanners is depicted in Diagram C. Specifically, Affymetrix HG U133 A gene expression profiling data obtained from the new GeneChip Fluidics Station 450 and the GeneChip Scanner 3000 can be converted through quantile normalization using a universal reference standard generated from the microarray data collected with an earlier generation of the instruments, as above. After such normalization, the microarray data become quivalent to the microarray data obtained from the use of the earlier generation of instrument. The normalized data can then be analyzed for clinical application.

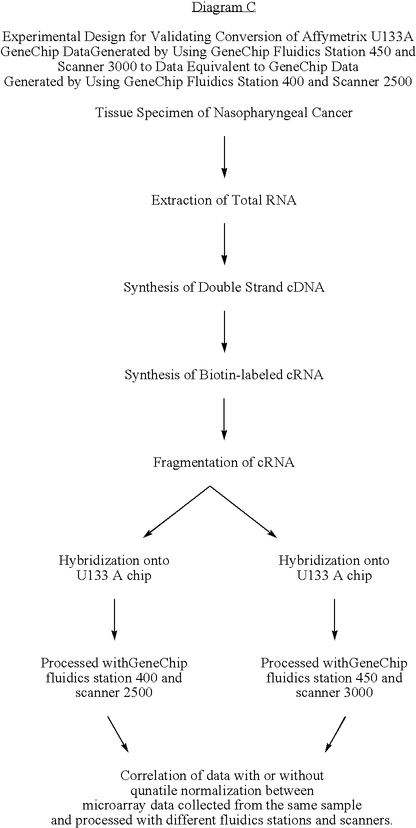

### EXAMPLE 8

The procedures to determine gene expression profiling data from patient tissues by using Affymetrix U-133A GeneChips are the same as described in Example 1. For the study as depicted in Diagram C, fragmented biotin-labled cRNA from the same sample was divided into two aliquots. Fifteen micrograms of the fragmented cRNA from each aliquot were hybridized onto a U133A GeneChip and processed with the new or old fluidics station plus scanner, separately (Diagram C). The gene expression intensities were obtained using Affymatrix MAS 5.0 software. Six nasopharyngeal cancer samples were randomly selected for the study.

### EXAMPLE 9

Quantile normalization of the gene expression intensity data was performed as described in Example 2. The universal reference standard established in the foregoing examples was used for quantile normalization.

### EXAMPLE 10

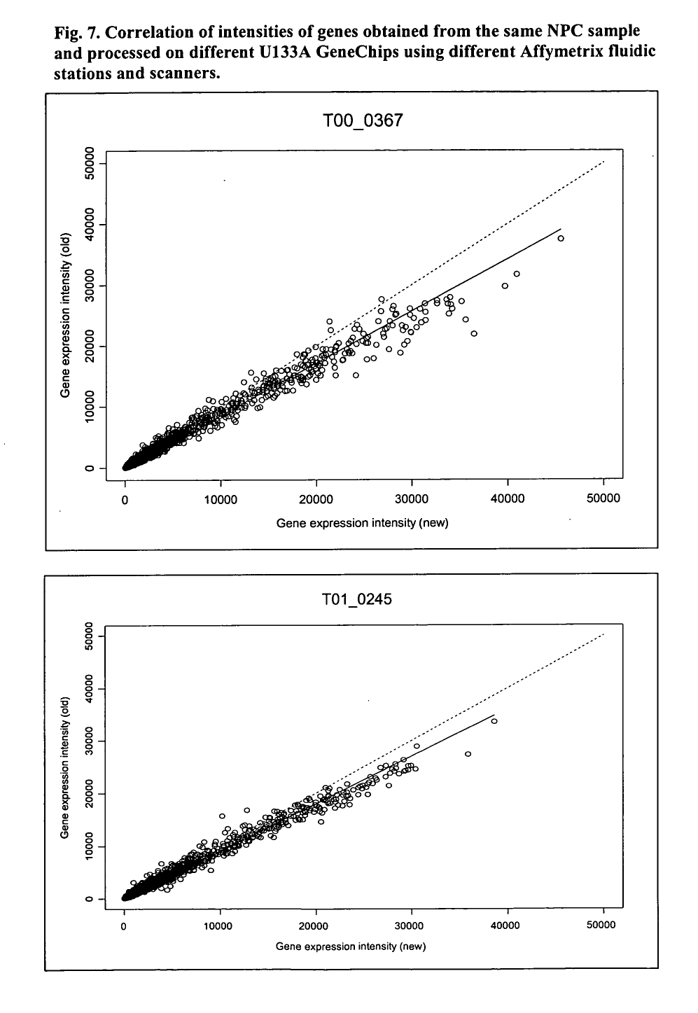

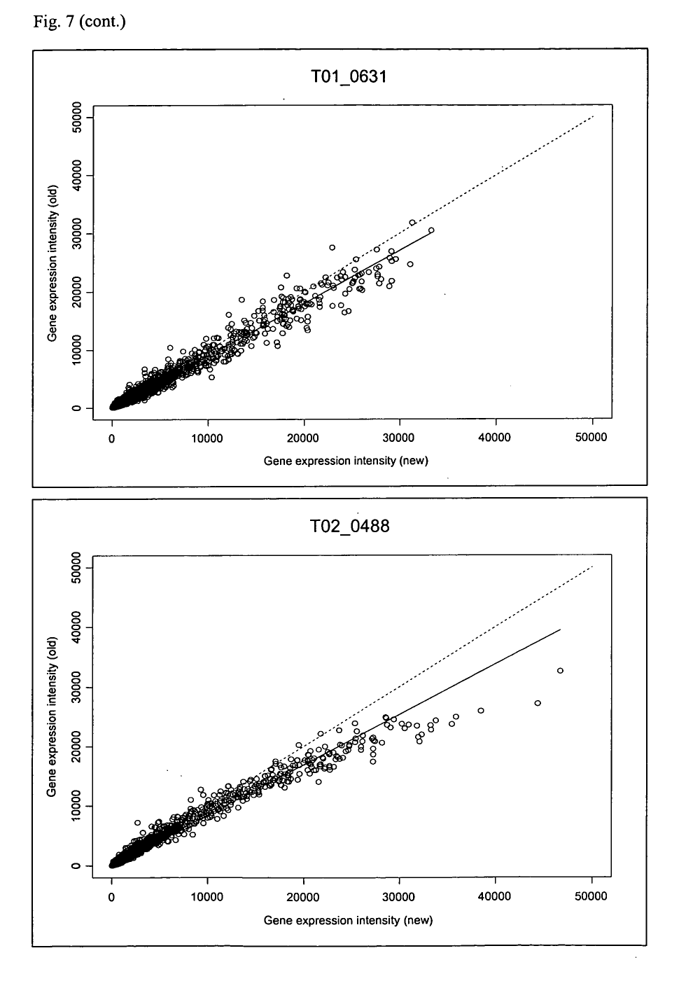

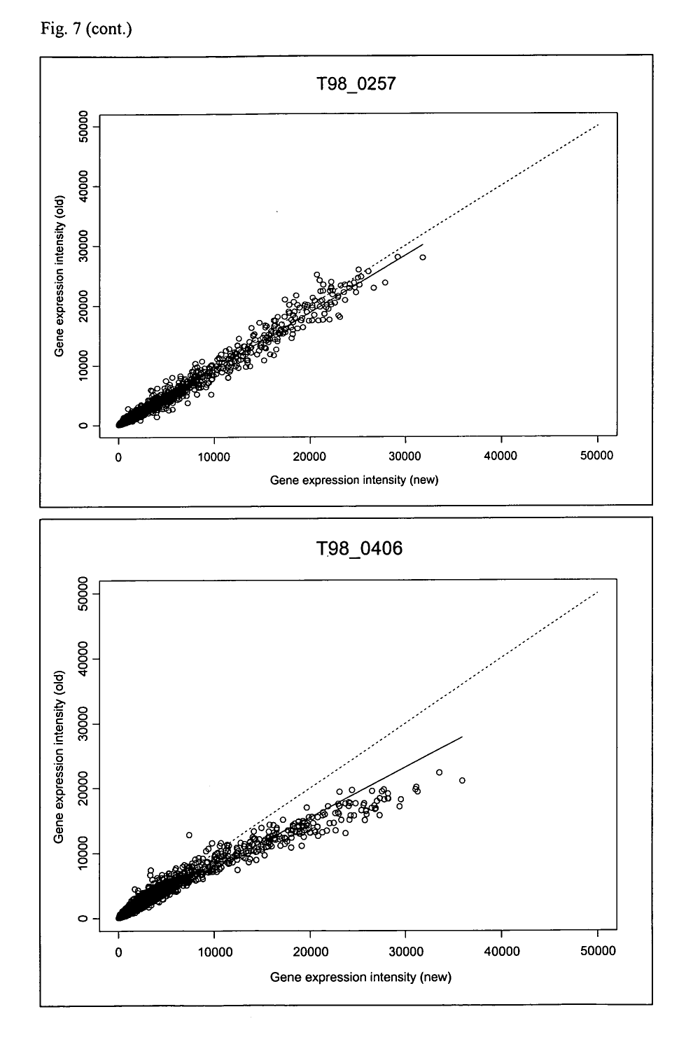

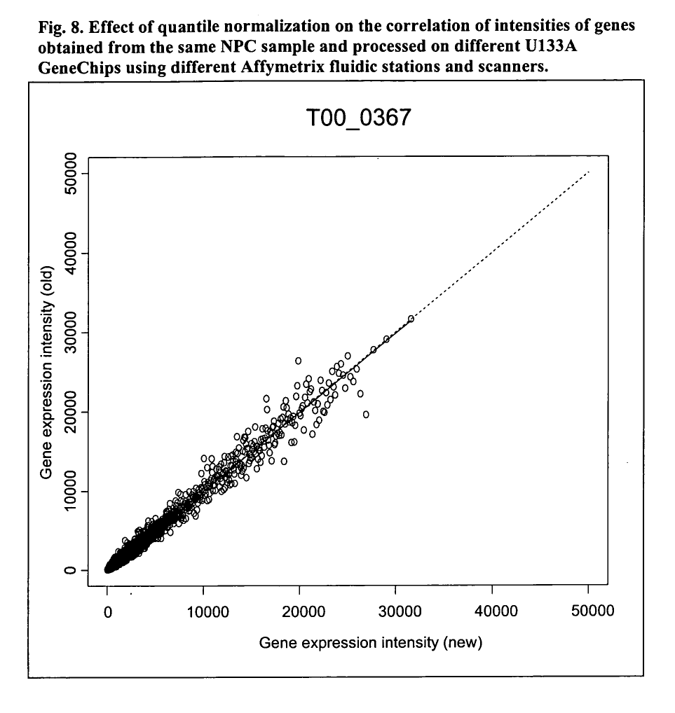

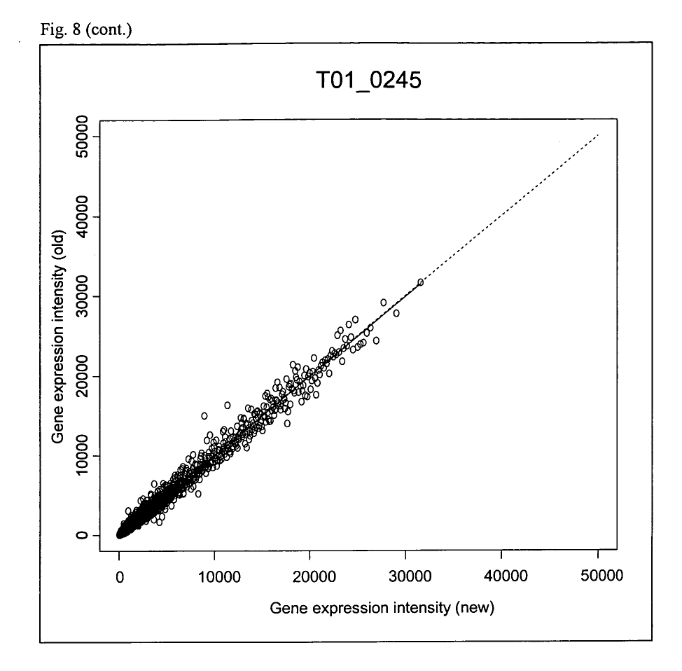

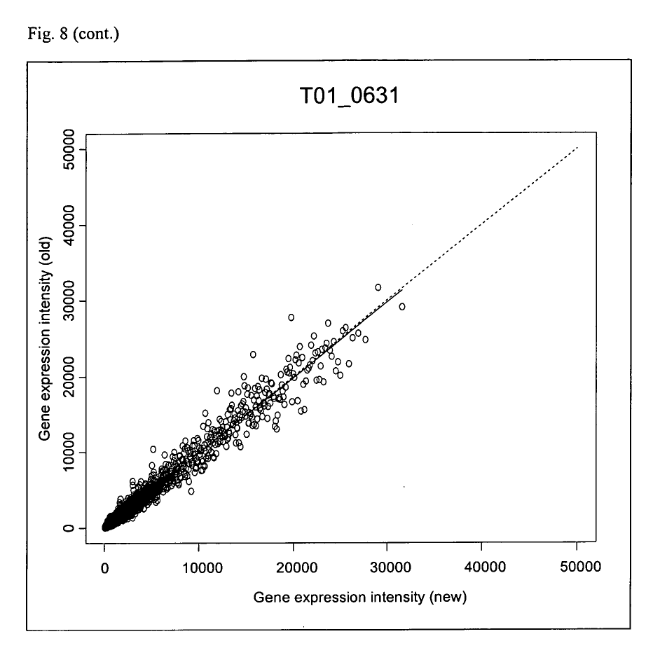

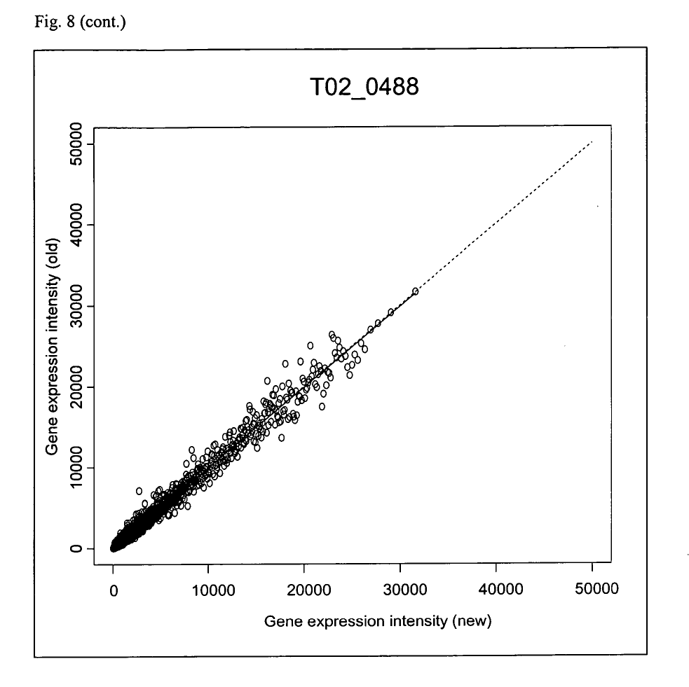

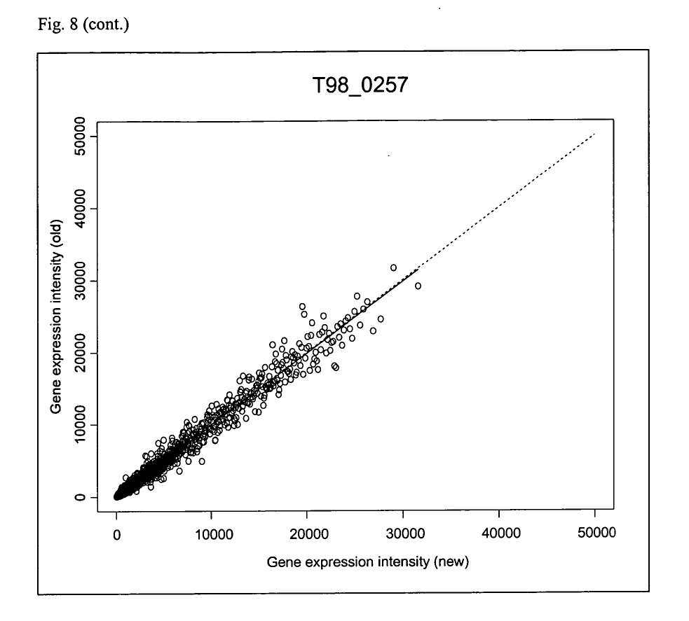

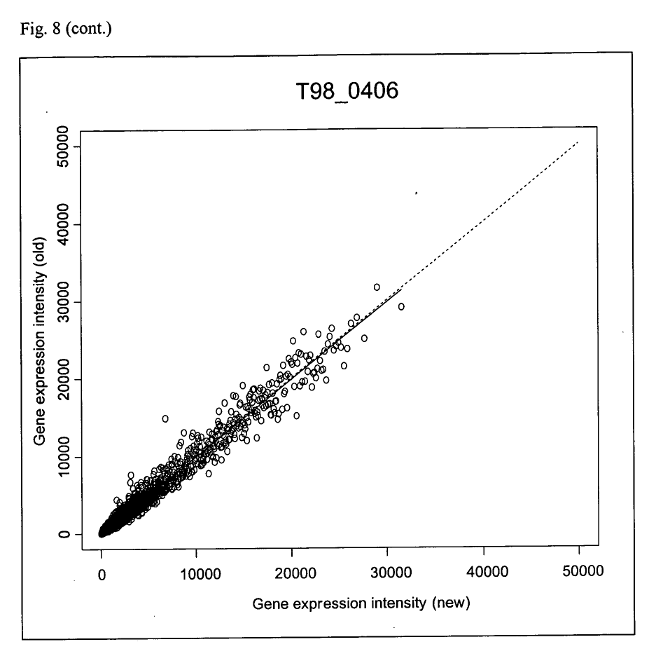

The expression intensities of each human gene determined by processing a U133A GeneChip through the old or the new Affymetrix fluidic station and scanner were obtained by using Affymetrix MAS 5.0 software as described in the foregoing examples and were correlated with each other before and after quantile normalization for each NPC sample. The procedure of “quantile normalization” to a universal reference standard was as detailed above. Linear regression analyses were performed by using S-plus 6 software (Insightful Corp.). The results are shown in FIGS. 7 and 8. The regression lines were drawn in solid lines. The values of all slopes in FIGS. 7 and 8 are shown in Table 2. The results show that the gene expression intensities measured by the use of the new generation fluidic station and scanner are higher than those measured by the use of old generation instrument (FIG. 7). The regression lines of gene intensities after quantile normalization are essentially superimposed with the ideal diagonal lines (FIG. 8). The results validate that quantile normalization to the universal reference standard can be utilized to correct deviations resulting from the use of new generation of instruments.

TABLE 1
Comparison of standard deviations (SD) of gene expression
before and after quantile normalization (QN)¹.

| | | | SD of Log₂ | |
|---|---|---|---|---|
| | SD of Raw Intensity² | | Transformed Intensity³ | |
| | Before QN | After QN | Before QN | After QN |
| Minimum | 1.72 | 0.74 | 0.18 | 0.08 |
| 1^{st} Quantile | 52.98 | 48.93 | 0.43 | 0.42 |
| Median | 258.54 | 238.72 | 0.69 | 0.68 |
| 3^{rd} quantile | 227.49 | 226.79 | 0.88 | 0.87 |
| Maximum | 12502.58 | 7941.05 | 3.71 | 3.75 |
| Overall Mean | 258.54 | 238.72 | 0.69 | 0.68 |
| of standard | | | | |
| deviations⁴ | | | | |

¹Standard deviations of expression intensity of each gene before and after quantile normalization to the reference standard 4 were calculated for 164 primary NPC samples. The calculation was made for intensities with and without Log₂ transformation.
²The raw intensities without log₂ transformation were obtained by using MAS 5.0 and scaled to a trimmed mean of 500 and were used for calculation of standard deviations of each gene.
³Log₂ transformation of raw intensities were used for calculation of a standard deviation of each gene.
⁴Paired t test was used to compare the means of standard deviations before and after quantile normalization. The results indicate that the standard deviations were smaller after quantile normalization and p values for two sets of data were <0.0001.
Standard deviation values of minimum, 1^{st} quantile, median, 3^{rd} quantile, maximum and overall mean of standard deviations before and after quantile normalization to the reference standard 4 are listed in the table.

TABLE 2
Slope of linear regression lines shown in FIGS. 7 and 8
Linear Regression Slopes of NPC Samples

| | T00- | T01- | T01- | T02- | T98- | T98- |
|---|---|---|---|---|---|---|
| | 0367 | 0245 | 0631 | 0488 | 0257 | 0406 |
| Before | 0.856 | 0.901 | 0.901 | 0.845 | 0.945 | 0.774 |
| Quantile | | | | | | |
| Normal- | | | | | | |
| ization | | | | | | |
| (FIG. 7) | | | | | | |
| After | 0.994 | 0.995 | 0.989 | 0.994 | 0.992 | 0.991 |
| Quantile | | | | | | |
| Normal- | | | | | | |
| ization | | | | | | |
| (FIG. 8) | | | | | | |

The entire disclosures of all applications, patents and publications, cited herein are incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

### REFERENCES

1. Golub T R, et. al. Molecular classification of cancer: class discovery and class prediction by gene expression monitoring. Science 286:531-537, 1999.
2. Bittner M, et. al. Molecular classification of cutaneous malignant melanoma by gene expression profiling. Nature 406:536-540, 2000.
3. Perou C M, et. Al. Molecular portraits of human breast tumors. Nature 406:747-752, 2000.
4. Hedenfalk I, et. Al. Gene-expression profiles in hereditary breast cancer. New Eng J Med 344:539-548, 2001.
5. Khan J, et. al. Classification and diagnostic prediction of cancer using gene expression profiling and artificial neural networks. Nature Med 7:673-679, 2001.
6. Alizadeh A A, et. al. Distinct types of diffuse large B-cell lymphoma identified by gene expression profiling. Nature 403:503-511, 2000.
7. Dhanasekaran S M, et. al. Delineation of prognostic biomarkers in prostate cancer. Nature 412:822826, 2001.
8. Shirota y, et al. Identification of differentially expressed genes in hepatocellular carcinoma with cDNA microarrays. Hepatology 33:832-840, 2001.
9. Ramaswamy S, et. al. Multiclass cancer diagnosis using tumor gene expression signatures. PNAS 98:15149-15154, 2001.
10. van't Veer L J, et. al. Gene expression profiling predicts clinical oputcome of breast cancer. Nature 415:530-536, 2002.
11. Shipp M A, et. al. Diffuse large B-cell lymphoma outcome prediction by gene-expression profiling and supervised machine learning. Nature Med 8:68-74, 2002.
12. Armstrong S A, et al. MLL translocations specify a distinct gene expression profile that distinguishes a unique leukemia. Nature Genetics 30:41-47, 2002.
13. Bolstad et al. A comparison of normalization methods for high density oligonucleotide array data based on variance and bias. Bioinformatics 19:185-193, 2003.
14. Park T et al. Evaluation of normalization methods for microarray data BMC Bioinformatics 4:33-45, 2003.
15. Benito M. et al. Adjustment of systematic microarray data biases. Bioinformatics 20:105-114, 2004.
16. Sorlie T, et al. Repeated observation of breast tumor subtypes in independent gene expression data sets. Proc Nat Acad Sci, USA 100:8418-8423, 2003.

1. A method of normalizing gene expression data obtained on a given microarray for a particular biological sample comprising normalizing said data using reference standard gene expression data, which was obtained on a microarray containing the same genes as said given microarray by measuring expression of said genes from different sets of biological samples different from said particular sample, averaging expression data for each gene within said sets to calculate reference standard expression values for said genes for each set, and determining that the correlations of said reference standard values among said sets are sufficiently highly significant that the reference standard values for each set are essentially identical.

2. A method of normalizing gene expression data obtained on a given microarray for a particular biological sample, comprising sorting said data as a function of expression degree for each gene, sorting a reference standard of gene expression data according to the same function of expression degree, and normalizing the expression degree of said particular gene expression data to the corresponding value in the reference standard, the reference standard having been obtained from gene expression data which is other than said particular gene expression data.

3. A method of claim 2 wherein said reference standard was obtained on a microarray containing the same genes as said given microarray by measuring expression of said genes from sets of biological samples different from said particular sample, averaging expression data for each gene within said sets to calculate reference standard expression values for said genes for each set, and determining that the correlations of said reference standard values among said sets are sufficiently highly significant that the reference standard values for each set are essentially identical.

4. A method of claim 3 wherein said reference standard was obtained by arranging the expression intensities of the genes of each of the biological samples in ascending or descending order and calculating the arithmetic mean across each position in said ordering, the resulting set of mean values constituting the reference standard.

5. A method of claim 4 wherein the number of biological samples is five or more.

6. A method of claim 4 wherein the number of biological samples is fifty or more.

7. A method of claim 4 wherein said normalization is quantile normalization.

8. A method of claim 6 wherein said normalization is quanitile normalization.

9. A method of claim 7 wherein said particular biological sample comprises nasopharyngeal tissue which is normal and/or cancerous.

10. A method according to claim 9 wherein the biological samples used to obtain the reference standard comprise nasopharyngeal tissue which is normal and/or cancerous.

11. A method according to claim 7 wherein the biological samples used to obtain the reference standard comprise nasopharyngeal tissue which is normal and/or cancerous.

12. A method of claim 11 wherein said particular biological sample comprises tissue other than nasopharyngeal tissue.

13. A method of claim 12 wherein said particular biological sample comprises normal and/or cancerous liver tissue.

14. A reference standard for quantile normalization of gene expression data comprising the gene expression data of the file “Reference Standards.txt” in the appended CD.

15. A method of claim 2 wherein said reference standard is that of the file “Reference Standards.txt” in the appended CD and the normalization method is quantile normalization.

16. A method of claim 2 wherein said gene expression data to be normalized is obtained on said given microarray by use of first associated instrumentation and wherein said reference standard data is obtained on an equivalent microarray by use of second associated instrumentation different from said first associated instrumentation.

17. A method of claim 16 wherein said second associated instrumentation is a later generation of said first associated instrumentation.

18. A method of claim 17 wherein said instrumentation comprises a fluidics station and a gene array scanner.
